(19) United States
(12) Patent Application Publication
(10) Pub. No.: US 2024/0021093 A1
(43) Pub. Date: Jan. 18, 2024

(54) RUNWAY OVERRUN PREDICTION SYSTEM AND METHOD

(71) Applicant: HONEYWELL INTERNATIONAL INC., Charlotte, NC (US)

(72) Inventors: Anantha Chandrasekhar Koduru, Hyderabad (IN); Yasuo Ishihara, Phoenix, AZ (US); Supratik Gon, Bangalore (IN); Yogesh Gharote, Bangalore (IN)

(73) Assignee: HONEYWELL INTERNATIONAL INC., Charlotte, NC (US)

(21) Appl. No.: 17/822,463

(22) Filed: Aug. 26, 2022

(30) Foreign Application Priority Data
Jul. 13, 2022 (IN) 202211040197

(51) Int. Cl. G08G 5/02; G08G 5/00; G01S 13/95; G01S 13/53; G01S 17/95; G01W 1/08

(52) U.S. Cl. CPC G08G 5/025; G08G 5/0091; G01S 13/953; G01S 13/53; G01S 17/95; G01W 1/08; G01W 2001/003

(57) ABSTRACT

A runway overrun prediction system for an aircraft includes a doppler wind measurement system and a runway overrun awareness and alerting system (ROAAS). The doppler wind measurement system is disposed at least partially within the aircraft. The doppler wind measurement system is configured to continuously measure a doppler signature of a wind field over an estimated touchdown zone on a runway ahead of the aircraft and supply wind data representative of the doppler signature. The ROAAS is disposed within the aircraft and is configured to determine a ROAAS model distance (RMD) for the aircraft. The ROAAS is in operable communication with the doppler wind measurement system and is coupled to receive the wind data therefrom. The ROAAS is further configured, upon receipt of the wind data, to adjust the RMD for the aircraft based on the wind data.

### CROSS-REFERENCE TO RELATED APPLICATION

This application claims priority to India Provisional Patent Application No. 202211040197, filed Jul. 13, 2022, the entire content of which is incorporated by reference herein.

### TECHNICAL FIELD

The present invention generally relates to runway overrun prediction, and more particularly relates to wind-compensated runway overrun prediction systems and methods.

### BACKGROUND

Runway overruns upon landing are considered one of the greatest operational risks in commercial air transport. Thus, many commercial aircraft include a runway overrun and awareness system (ROAAS). The ROAAS provides display and alerting that helps increase pilot situational awareness and decrease workload by providing information on predicted touch down points, stopping points, the selected runway and the available landing distance using manufacturer provided performance metrics. The data is determined mainly with current aircraft configuration that includes speed, position, trajectory, flight path vector, runway condition, autobrake selection, etc. The data is compiled and relayed as both visual and aural alerts to the flight crew.

Although generally reliable and robust, the current ROAAS does not account for windspeed at or near the planned/predicted touchdown point on the runway until the aircraft arrives at the touchdown point. As is generally known, windspeed can significantly impact aircraft groundspeed upon a landing approach, which in turn can impact the actual (and predicted) landing distance.

Hence, there is a need for a system and method that provides wind-compensated runway overrun prediction. The present disclosure addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a runway overrun prediction system for an aircraft includes a doppler wind measurement system and a runway overrun awareness and alerting system (ROAAS). The doppler wind measurement system is disposed at least partially within the aircraft. The doppler wind measurement system is configured to continuously measure a doppler signature of a wind field over an estimated touchdown zone on a runway ahead of the aircraft and supply wind data representative of the doppler signature. The ROAAS is disposed within the aircraft and is configured to determine a ROAAS model distance (RMD) for the aircraft. The ROAAS is in operable communication with the doppler wind measurement system and is coupled to receive the wind data therefrom. The ROAAS is further configured, upon receipt of the wind data, to adjust the RMD for the aircraft based on the wind data.

In another embodiment, a method for predicting runway overrun for an aircraft includes continuously measuring, using a doppler wind measurement system disposed at least partially within the aircraft, a doppler signature of a wind field over an estimated touchdown zone on a runway ahead of the aircraft, and generating and supplying, with the doppler wind measurement system, wind data representative of the doppler signature. In a runway overrun awareness and alerting system (ROAAS) that is disposed within the aircraft and that is configured to determine a ROAAS model distance (RMD) for the aircraft, the wind data are processed to adjust the RMD for the aircraft.

In yet another embodiment, an aircraft includes a fuselage, a doppler wind measurement system, and a runway overrun awareness and alerting system (ROAAS). The doppler wind measurement system is disposed at least partially within the fuselage. The doppler wind measurement system is configured to continuously measure a doppler signature of a wind field over an estimated touchdown zone on a runway ahead of the aircraft and supply wind data representative of the doppler signature. The ROAAS is disposed within the fuselage and is configured to determine a ROAAS model distance (RMD) for the aircraft. The ROAAS is in operable communication with the doppler wind measurement system and is coupled to receive the wind data therefrom. The ROAAS is further configured, upon receipt of the wind data, to adjust the RMD for the aircraft based on the wind data.

Furthermore, other desirable features and characteristics of the runway overrun prediction system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a functional block diagram of one embodiment of a runway overrun prediction system;

FIG. 2 depicts an aircraft having the system of FIG. 1 on approach to a runway; and

FIG. 3 depicts a process, in flowchart form, of a method that may be implemented in the system of FIG. 1.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

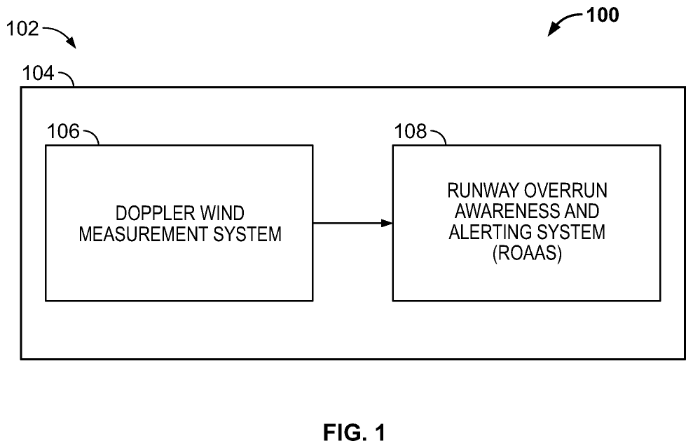

Referring to FIG. 1, one embodiment of a runway overrun prediction system 100 is depicted. The system 100 is disposed on or within an aircraft 102, and more specifically on or within the aircraft fuselage 104, and includes a doppler wind measurement system 106 and a runway overrun awareness and alerting system (ROAAS) 108. The doppler wind measurement system 106 is disposed at least partially within the fuselage 104 and is configured to continuously measure the doppler signature of a wind field ahead of the aircraft 102. More specifically, it is configured to continuously measure the doppler signature of a wind field over an estimated touchdown zone on a runway ahead of the aircraft 102 and to supply wind data representative of the doppler signature.

To implement its functionality, the doppler wind measurement system 106 may be implemented using a radar system or a lidar system. In both instances, whether a radar system or a lidar system, the doppler wind measurement system 106 will preferably use a coherent radar or lidar system that transmits a coherent pulse train and is capable of measuring a doppler signature. Many currently known aircraft radar systems, such as onboard weather radar, and currently known lidar system are pulse doppler radars/lidars by design and can readily measure the doppler signature of the wind field(s). Regardless of whether radar or lidar is used, the doppler wind measurement system 106 is preferably operable to continuously measure the doppler signature of the wind over the estimated touchdown zone at least 1 nautical mile (NM) ahead of the aircraft 102.

Before proceeding further, it is noted that the principle of operation is that the wind, owing to its velocity, imparts a shift in the transmitted frequency (i.e., the doppler) to the transmitted coherent pulse train. The doppler may be readily measured using any one of numerous spectrum estimation techniques, such as FFT (Fast Fourier Transform) or MUSIC (Multiple Signal Classification), The doppler characteristics, such as doppler spread, and dominant spectral modes, may then be estimated, and ground effects filtered out, to estimate the wind velocity. It should be noted that in some embodiments only the horizontal wind velocity along the line-of-sight of the radar/lidar system generates the doppler, since the doppler generated by wind velocity perpendicular to the line-of-sight is zero and cannot be measured. However, in other embodiments, the measured horizontal wind velocity, together with known empirical models, may be used to estimate the vertical wind velocity component for the range cells of interest.

Returning to the description, regardless of how the doppler wind measurement system 106 is specifically implemented, as was noted above it supplies wind data representative of the doppler signature to the ROAAS 108. The ROAAS 108 is disposed within the fuselage 102 and, as is generally known, is configured to determine a ROAAS model distance (RMD) for the aircraft 102. As is also generally known, the RMD is the stopping distance for the aircraft 102 that is calculated by a conventional ROAAS. However, the ROASS 108 in the system 100 of FIG. 1, is further configured, upon receipt of the wind data from the doppler wind measurement system 106, to adjust the RMD for the aircraft 102 based on the wind data.

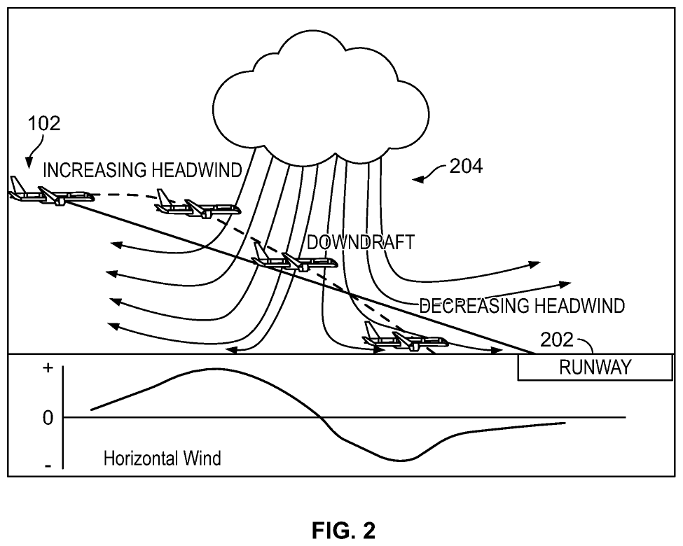

To illustrate the above-described functionality of the system 100, reference should now be made to FIG. 2, which depicts the aircraft 102 on approach to a runway 202. During the approach, the aircraft 102, at least in this example, encounters a wind field 204 having a horizontal component that, to the aircraft 102, initially presents itself as a headwind 204 that increases and then decreases in velocity magnitude until it transitions to a tail wind that increases and then decreases in velocity magnitude. The system 100 described herein takes into account the variations in velocity magnitude to provide more accurate potential runway overrun predictions.

It should be noted that although FIG. 2 depicts an approach phase for the aircraft 102, the system 100 can be extended to take-off scenarios as well. Moreover, although the wind field 204 depicted in FIG. 2 is more reminiscent of a wind shear profile, it will be appreciated that the wind field 204 could be a headwind, a tailwind, or a combination of both.

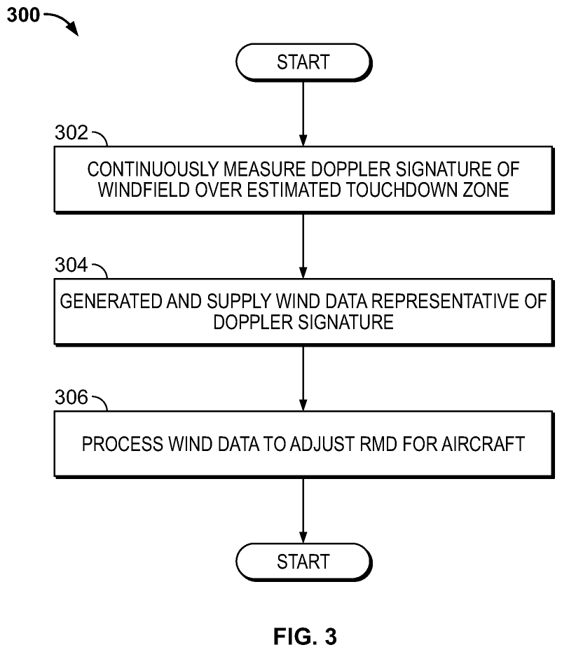

Having described the overall functionality of the system 100, a description of a method for predicting runway overrun for an aircraft that is implemented in the system 100 will be described. The method 300, which is depicted in flowchart form in FIG. 3, represents various embodiments of a method for predicting runway overrun for an aircraft. For illustrative purposes, the following description of method 300 may refer to elements mentioned above in connection with FIG. 1. In practice, portions of method 300 may be performed by different components of the described system 100. It should be appreciated that method 300 may include any number of additional or alternative tasks, the tasks shown in FIG. 3 need not be performed in the illustrated order, and method 300 may be incorporated into a more comprehensive procedure or method having additional functionality not described in detail herein. Moreover, one or more of the tasks shown in FIG. 3 could be omitted from an embodiment of the method 300 if the intended overall functionality remains intact.

The method 300 starts and the doppler wind measurement system 106 continuously measures the doppler signature of a wind field over an estimated touchdown zone on a runway ahead of the aircraft 102 (302). The doppler wind measurement system 106 also generates and supplies wind data representative of the doppler signature (304). The ROASS 108 processes the wind data to adjust the RMD for the aircraft (306).

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A runway overrun prediction system for an aircraft, comprising:
a doppler wind measurement system disposed at least partially within the aircraft, the doppler wind measurement system configured to continuously measure a doppler signature of a wind field over an estimated touchdown zone on a runway ahead of the aircraft and supply wind data representative of the doppler signature; and
a runway overrun awareness and alerting system (ROAAS) disposed within the aircraft and configured to determine a ROAAS model distance (RMD) for the aircraft, the ROAAS in operable communication with the doppler wind measurement system and coupled to receive the wind data therefrom, the ROAAS further configured, upon receipt of the wind data, to adjust the RMD for the aircraft based on the wind data.

2. The system of claim 1, wherein the doppler wind measurement system comprises a radar system.

3. The system of claim 1, wherein the doppler wind measurement system comprises a lidar system.

4. The system of claim 1, wherein the doppler wind measurement system is operable to continuously measure the doppler signature of the wind over the estimated touchdown zone at least 1 nautical mile (NM) ahead of the aircraft.

5. The system of claim 1, wherein:
the wind field includes a horizontal component and a vertical component; and
the doppler wind measurement system continuously measures the doppler signature of the horizontal component of the wind field.

6. The system of claim 5, wherein the doppler wind measurement system is further configured to estimate the vertical component of the wind field using empirical models.

7. The system of claim 1, wherein the doppler wind measurement system is configured to measure the doppler signature of a wind field by:
transmitting a coherent pulse train; and
measuring a doppler in the transmitted coherent pulse train using standard spectrum estimation techniques;
estimating the doppler characteristics; and
filtering out ground returns.

8. A method for predicting runway overrun for an aircraft, comprising the steps of:
continuously measuring, using doppler wind measurement system disposed at least partially within the aircraft, a doppler signature of a wind field over an estimated touchdown zone on a runway ahead of the aircraft;
generating and supplying, with the doppler wind measurement system, wind data representative of the doppler signature; and
in a runway overrun awareness and alerting system (ROAAS) that is disposed within the aircraft and that is configured to determine a ROAAS model distance (RMD) for the aircraft, processing the wind data to adjust the RMD for the aircraft.

9. The method of claim 8, wherein the doppler wind measurement system comprises a radar system.

10. The method of claim 8, wherein the doppler wind measurement system comprises a lidar system.

11. The method of claim 8, wherein the doppler wind measurement system is operable to continuously measure the doppler signature of the wind over the estimated touchdown zone at least 1 nautical mile (NM) ahead of the aircraft.

12. The method of claim 8, wherein:
the wind field includes a horizontal component and a vertical component; and
the doppler wind measurement system continuously measures the doppler signature of the horizontal component of the wind field.

13. The method of claim 12, wherein the doppler wind measurement system is further configured to estimate the vertical component of the wind field using empirical models.

14. The method of claim 8, wherein the doppler wind measurement system is configured to measure the doppler signature of a wind field by:
transmitting a coherent pulse train; and
measuring a doppler in the transmitted coherent pulse train using standard spectrum estimation techniques;
estimating the doppler characteristics; and
filtering out ground returns.

15. An aircraft, comprising:
a fuselage;
a doppler wind measurement system disposed at least partially within the fuselage, the doppler wind measurement system configured to continuously measure a doppler signature of a wind field over an estimated touchdown zone on a runway ahead of the aircraft and supply wind data representative of the doppler signature; and
a runway overrun awareness and alerting system (ROAAS) disposed within the fuselage and configured to determine a ROAAS model distance (RMD) for the aircraft, the ROAAS in operable communication with the doppler wind measurement system and coupled to receive the wind data therefrom, the ROAAS further configured, upon receipt of the wind data, to adjust the RMD for the aircraft based on the wind data.

16. The aircraft of claim 15, wherein the doppler wind measurement system comprises a radar system.

17. The aircraft of claim 15, wherein the doppler wind measurement system comprises a lidar system.

18. The aircraft of claim 15, wherein the doppler wind measurement system is operable to continuously measure the doppler signature of the wind over the estimated touchdown zone at least 1 nautical mile (NM) ahead of the aircraft.

19. The aircraft of claim 15, wherein:
the wind field includes a horizontal component and a vertical component;
the doppler wind measurement system continuously measures the doppler signature of the horizontal component of the wind field; and
the doppler wind measurement system is further configured to estimate the vertical component of the wind field using empirical models.

20. The aircraft of claim 15, wherein the doppler wind measurement system is configured to measure the doppler signature of a wind field by:
transmitting a coherent pulse train; and
measuring a doppler in the transmitted coherent pulse train using standard spectrum estimation techniques;
estimating the doppler characteristics; and
filtering out ground returns.
